(19) United States
(12) Patent Application Publication
(10) Pub. No.: US 2005/0211916 A1
(43) Pub. Date: Sep. 29, 2005

(54) Radiation image storage panel

(75) Inventors: Hiroshi Matsumoto, Kanagawa (JP); Seiji Tazaki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/078,336

(22) Filed: Mar. 14, 2005

(30) Foreign Application Priority Data
Mar. 12, 2004 (JP) 2004-071536

(51) Int. Cl. G03B 42/08

(52) U.S. Cl. 250/484.4

(57) ABSTRACT

A radiation image storage panel is composed of a metal sheet and a phosphor layer formed on one surface of the metal sheet by gas phase-accumulation, in which the metal sheet has a surface having a surface roughness Ra of 0.1 μm or lower.

### FIELD OF THE INVENTION

The present invention relates to a radiation image storage panel employable in a radiation image recording and reproducing method utilizing an energy-storable phosphor.

### BACKGROUND OF THE INVENTION

When an energy-storable phosphor (e.g., stimulable phosphor, which gives off stimulated emission) is exposed to radiation such as X-rays, it absorbs and stores a portion of energy of the radiation. The phosphor then produces stimulated emission according to the level of the stored energy when exposed to electromagnetic wave such as visible or infrared light (i.e., stimulating light). A radiation image recording and reproducing method utilizing the energy-storable phosphor has been widely employed in practice. In this method, a radiation image storage panel, which is a sheet comprising the energy-storable phosphor, is used. The method comprises the steps of; exposing the storage panel to radiation having passed through an object or having radiated from an object, so that radiation image of the object is temporarily recorded in the storage panel; sequentially scanning the storage panel with a stimulating light such as a laser beam to emit a stimulated light; and photoelectrically detecting the emitted light to obtain electric image signals. The storage panel thus processed is then subjected to a step for erasing radiation energy remaining therein, and then stored for the use in the next recording and reproducing procedure. Thus, the radiation image storage panel can be repeatedly used.

The radiation image storage panel (often referred to as an energy-storable phosphor sheet) has a basic structure comprising a support and a phosphor layer provided thereon. Further, a protective layer is generally provided on the free surface (surface not facing the support) of the phosphor layer to keep the phosphor layer from chemical deterioration or physical damage.

Various kinds of phosphor layers are known. For example, a phosphor layer comprising a binder and energy-storable phosphor particles dispersed therein is generally used, and a phosphor layer comprising agglomerate of an energy-storable phosphor without binder is known. The latter phosphor layer can be formed by a gas phase-accumulation method.

The radiation image recording and reproducing method (or radiation image forming method) has various advantages. It is still desired that the radiation image storage panel have as high sensitivity as possible and, at the same time, give a reproduced radiation image of high quality (in regard to sharpness and graininess).

It is known that the phosphor layer of the radiation image storage panel prepared by a gas phase-accumulation method such as vacuum vapor deposition, sputtering, or chemical vapor deposition (CVD) shows high sensitivity and gives a reproduced radiation image of high quality. The process of vacuum vapor deposition, for example, comprises the steps of: heating to vaporize an evaporation source comprising a phosphor or its starting materials by means of a resistance heater or an electron beam, and depositing and accumulating the produced vapor on a substrate (i.e., support) such as a metal sheet to form a layer of the phosphor in the form of columnar crystals.

The phosphor layer formed by the gas phase-accumulation method contains no binder and consists essentially of phosphor, and there are formed vertically extended gaps among the columnar crystals of the phosphor. Due to the presence of these gaps in the phosphor layer, the stimulating light can stimulate the phosphor efficiently and the emitted light can be taken out efficiently. Accordingly, a radiation image storage panel having such phosphor layer shows high sensitivity. Further, since the gaps in the phosphor layer prevent the stimulating light from diffusing in parallel with the phosphor layer, the radiation image storage panel can give a reproduced radiation image of high sharpness.

Japanese Patent Provisional Publication 4-118599 describes an X-ray image conversion sheet comprising a stimulable phosphor layer and an aluminum substrate in which a white oxide layer is placed between the aluminum substrate and the phosphor layer. The Publication further described an X-ray image conversion sheet comprising a black aluminum substrate having been subjected to anodic oxidation and a stimulable phosphor layer.

Japanese Patent No. 2,514,321 describes a radiation image conversion panel comprising a light-reflective layer having a smooth surface on a side opposite to a side receiving a stimulating light so that the sensitivity of the conversion panel can be enhanced and the sharpness of a reproduced radiation image is improved. One working example indicates that the support is an aluminum sheet having a clear surface which is obtained by washing the surface to remove stains.

It is now found that when a metal sheet (substrate) having a rough surface on which unevenness is formed in its depth direction is employed in the manufacture of a phosphor layer of a radiation image storage panel by gas phase-accumulation, abnormal phosphor crystals grows on the uneven area of the metal sheet even if the unevenness is not prominent. If the abnormally grown phosphor crystals have a crystal size larger than the pixel size adopted in reproduction of the radiation image, there are produced defective points on the reproduced radiation image. The defective point has an optical density apparently differing from the optical density of an area surrounding the defective point. The presence of these defective points in the reproduced radiation image disturbs clinical examination and detection of defective area of the examined object. Moreover, since the phosphor layer produced by gas phase-accumulation has a high transparency, a radiation image reproduced using a radiation image storage panel having a uneven substrate tends to have unevenness. The unevenness appearing on the reproduced radiation image increases structural mottle (particle fluctuation between pixels) and hence worsens graininess of the reproduced radiation image.

### SUMMARY OF THE INVENTION

The present inventors have studied on the problems mentioned above. As a result, they have found that if the metal sheet (substrate or support) having a roughness in terms of Ra lower than a certain level is employed for the formation of a phosphor layer on the metal sheet by gas phase-accumulation, the structural mottle which worsens graininess of the reproduced radiation image is reduced and hence the defective points on the reproduced radiation image are decreased.

Accordingly, the present invention resides in a radiation image storage panel comprising a metal sheet and a phosphor layer formed on one surface of the metal sheet by gas phase-accumulation, in which the metal sheet has a surface having a surface roughness Ra of 0.1 μm or lower.

The radiation image storage panel of the invention preferably has a maximum height (in terms of Rz) of surface roughness of 1.5 μm or lower, more preferably 1.0 μm or lower.

The surface roughness (Ra) and the maximum height (Rz) of surface roughness are defined in JIS B 0601, In more detail, the surface roughness (Ra) is obtainable by the following method: The surface of the metal sheet is scanned by means of a microscope for measuring a surface ultra-depth condition (VK-8550, available from Keyence Corporation) in a square area (100 μm×100 μm) with a height-measuring pitch (measuring resolution) of 0.01 μm, and the resulting data are processed according to the calculation formula defined in JIS B 0601-1994 using a image measuring-analyzing software to give the desired surface roughness (in terms of arithmetic mean roughness). The maximum height (Rz) of surface roughness can be determined by a similar method.

The radiation image storage panel of the invention can reproduce a radiation image of high quality with satisfactory graininess and less defective points. Accordingly, the radiation image storage panel of the invention is advantageously employable for clinical examination.

### BRIEF DESCRIPTION OF DRAWINGS

FIGURE shows a constitution of a radiation image storage panel.

### DETAILED DESCRIPTION OF INVENTION

The radiation image storage panel of the invention preferably has a surface roughness (Ra) in the range of 0.005 to 0.06 μm.

It is preferred that the surface of the metal sheet is polished or metal-plated (e.g., plated with nickel or chromium). Otherwise, the surface of the metal sheet can be coated with a transparent oxide layer.

In the radiation image storage panel of the invention, the phosphor layer preferably comprises columnar crystals of an energy-storable phosphor.

The energy-storable phosphor preferably is a stimulable alkali metal halide phosphor represented by the formula (I):
M^{I}X·aM^{II}X′₂·bM^{III}X″₃:zA (I)
in which M^{I} is at least one alkali metal selected from the group consisting of Li, Na, K, Rb and Cs; M^{II} is at least one alkaline earth metal or divalent metal selected from the group consisting of Be, Mg, Ca, Sr, Ba, Ni, Cu, Zn and Cd; M^{III} is at least one rare earth element or trivalent metal selected from the group consisting of Sc, Y, La, Ce, Pr, Nd, Pm, Sm, Eu, Cd, Tb, Dy, Ho, Er, Tm, Yb, Lu, Al, Ga and In; each of X, X′ and X″ is independently at least one halogen selected from the group consisting of F, Cl, Br and I; A is at least one rare earth element or metal selected from the group consisting of Y, Ce, Pr, Nd, Sm, Eu, Gd, Tb, Dy, Ho, Er, Tm, Yb, Lu, Mg, Cu and Bi; and a, b and z are numbers satisfying the conditions of 0≦a<0.5, 0≦b<0.5 and 0<z<1.0, respectively.

In formula (1), M^{I} is Cs, X is Br, A is Eu, and z is a number satisfying the condition of 1×10⁻⁴≦z≦0.1.

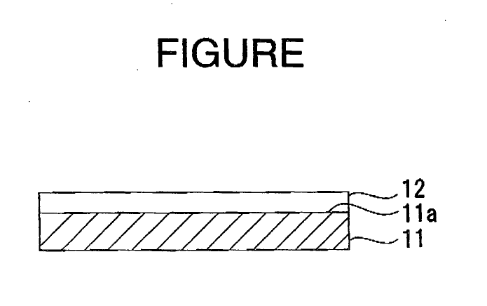

The radiation image storage panel of the invention is further described by referring to FIG. 1 in the attached drawing.

In FIG. 1, the radiation image storage panel comprises a metal sheet (i.e., support or substrate) 11 and a phosphor layer 12 formed by gas phase accumulation. The radiation image storage panel can have one or more auxiliary layers such as a protective layer, a reflective layer, and a subbing layer.

The metal sheet preferably can be made of aluminum, iron, tin, or chromium. It is preferred that the metal sheet is made of aluminum.

The surface 11a of the metal sheet 1 has a surface roughness (Ra) of 0.1 μm or lower, more preferably in the range of 0.005 to 0.06 μm. A metal sheet having a surface roughness of lower than 0.005 can be obtained only utilizing ultra-fine polishing technology. The use of ultra-fine polishing technology is not preferred from the view point of productivity.

As is described above, the surface of the metal sheet is preferably polished or metal-plated on its surface. Otherwise, the surface of the metal sheet has a transparent metal oxide layer. The surface of the metal sheet is preferably washed with an aqueous alkaline solution containing a surface active agent in advance of depositing a phosphor layer thereon for defatting oily stains on the sheet. In place of the washing or in addition to the washing, the surface of the metal sheet can be subjected to plasma washing using plasma produced in an atmosphere containing an inert gas such as Ar gas.

The energy-storable phosphor preferably is a stimulable phosphor giving off stimulated emission in the wavelength region of 300 to 500 nm when exposed to a stimulating ray in the wavelength region of 400 to 900 nm.

The phosphor particularly preferably is a stimulable alkali metal halide phosphor represented by the formula (I):
M^{I}X·aM^{II}X′₂·bM^{III}X″₃:zA (I)
in which M^{I} is at least one alkali metal selected from the group consisting of Li, Na, K, Rb and Cs; M^{II} is at least one alkaline earth metal or divalent metal selected from the group consisting of Be, Mg, Ca, Sr, Ba, Ni, Cu, Zn and Cd; M^{III} is at least one rare earth element or trivalent metal selected from the group consisting of Sc, Y, La, Ce, Pr, Nd, Pm, Sm, Eu, Gd, Tb, Dy, Ho, Er, Tm, Yb, Lu, Al, Ga and In; each of X, X′ and X″ is independently at least one halogen selected from the group consisting of F, Cl, Br and I; A is at least one rare earth element or metal selected from the group consisting of Y, Ce, Pr, Nd, Sm, Eu, Gd, Tb, Dy, Ho, Er, Tm, Yb, Lu, Mg, Cu and Bi; and a, b and z are numbers satisfying the conditions of 0≦a<0.5, 0≦b<0.5 and 0≦z<1.0, respectively.

In the formula (I), z preferably is a number satisfying the condition of 1×10⁻⁴≦z≦0.1; M^{I} preferably comprises at least Cs; X preferably comprises at least Br; and A is preferably Eu or Bi, more preferably Eu. The phosphor represented by the formula (I) may further comprise metal oxides such as aluminum oxide, silicon dioxide and zirconium oxide as additives in an amount of 0.5 mol or less based on one mol of M^{I}X.

As the phosphor, it is also preferred to use a rare earth activated alkaline earth metal fluoride halide stimulable phosphor represented by the formula (II):
M^{II}FX:zLn (II)
in which M^{II} is at least one alkaline earth metal selected from the group consisting of Ba, Sr and Ca; Ln is at least one rare earth element selected from the group consisting of Ce, Pr, Sm, Eu, Tb, Dy, Ho, Nd, Er, Tm and Yb; X is at least one halogen selected from the group consisting of Cl, Br and I; and z is a number satisfying the condition of 0<z≦0.2.

In the formula (II), M^{II} preferably comprises Ba more than half of the total amount of M^{II}, and Ln preferably is Bu or Ce. The M^{II}FX in the formula (II) represents a matrix crystal structure of BaFX type, and it by no means indicates stoichiometrical composition of the phosphor. Accordingly, the molar ratio of F:X is not always 1:1. It is generally preferred that the BaFX type crystal have many F⁺ (X⁻) centers corresponding to vacant lattice points of X⁻ ions since they increase the efficiency of stimulated emission in the wavelength region of 600 to 700 nm. In that case, F is often slightly in excess of X.

Although not described in the formula (II), one or more additives such as bA, wN^{I}, xN^{II} and yN^{III} may be incorporated into the phosphor of the formula (II). A is a metal oxide such as Al₂O₃, SiO₂ or ZrO₂. In order to prevent M^{II}FX particles from sintering, the metal oxide preferably has low reactivity with M^{II}FX and the primary particles of the oxide are preferably super-fine particles of 0.1 μm or less diameter. N^{I} is a compound of at least one alkali metal selected from the group consisting of Li, Na, K, Rb and Cs; N^{II} is a compound of alkaline earth metal(s) Mg and/or Be; and N^{III} is a compound of at least one trivalent metal selected from the group consisting of Al, Ga, In, Tl, Sc, Y, La, Gd and Lu. The metal compounds preferably are halides, but are not restricted to them.

In the formulas, b, w, x and y represent amounts of the additives incorporated into the starting materials, provided that the amount of M^{II}FX is assumed to be 1 mol. They are numbers satisfying the conditions of 0≦b≦0.5, 0≦w≦2, 0≦x≦0.3 and 0≦y≦0.3, respectively. These numbers by no means always represent the contents in the resultant phosphor because some of the additives decrease during the steps of firing and washing performed thereafter. Some additives remain in the resultant phosphor as they are added to the materials, but the others react with M^{II}FX or are involved in the matrix.

In addition, the phosphor of the formula (II) may further contain Zn and Cd compounds; metal oxides such as TiO₂, BeO, MgO, CaO, SrO, BaO, ZnO, Y₂O₃, La₂O₃, In₂O₃, GeO₂, SnO₂, Nb₂O₅, Ta₂O₅ and ThO₂; Zr and Sc compounds; B compounds; As and Si compounds; tetrafluoro-borate compounds; hexafluoro compounds such as monovalent or divalent salts of hexa-fluorosilicic acid, hexafluoro-titanic acid and hexa-fluorozirconic acid; or compounds of transition metals such as V, Cr, Mn, Fe, Co and Ni. The phosphor employable in the invention is not restricted to the above-mentioned phosphors, and any phosphor that can be essentially regarded as rare earth activated alkaline earth metal fluoride halide stimulable phosphor can be used.

Stimulable rare earth metal-activated alkaline earth metal sulfide phosphors having the following formula (III) are also preferred:
M^{II}S:A, Sm (III)

In the formula (III), M^{II} is an alkaline earth metal such as Mg, Ca or Sr, A is Eu or Ce.

Stimulable cerium-activated trivalent metal oxyhalide phosphors having the following formula (IV) are also preferred:
M^{III}OX:Ce (IV)

In the formula (IV), M^{III} represents at least one rare earth metal or trivalent metal such as Pr, Nd, Pm, Sm, Eu, Tb, Dy, Ho, Er, Tm, Yb or Bi; x is a halogen atom such as Cl, Br or I.

For the preparation of the radiation image storage panel of the invention, the phosphor layer is formed by gas phase-accumulation such as vapor deposition.

In the case where a phosphor layer is formed by multi-vapor deposition (co-deposition), at least two evaporation sources are used. One of the sources contains a matrix compound of the energy-storable phosphor, and the other contains an activator compound. The multi-vapor deposition is preferred because the vaporization rate of each source can be independently controlled to incorporate the activator uniformly in the matrix even if the compounds have very different melting points or vapor pressures. According to the composition of the desired phosphor, each evaporation source may consist of the matrix compound or the activator compound only or otherwise may be a mixture thereof with additives. Three or more sources may be used. For example. in addition to the above-mentioned sources, an evaporation source containing additives may be used.

The matrix compound of the phosphor may be either the matrix compound itself or a mixture of two or more substances that react with each other to produce the matrix compound. The activator compound generally is a compound containing an activating element, and hence is, for example, a halide or oxide of the activating element.

If the activator is Eu, the Eu-containing compound of the activator compound preferably contains Eu²⁺ as much as possible because the desired stimulated emission (even if, spontaneous emission) is emitted from the phosphor activated by Eu²⁺. Since commercially available Eu-containing compounds generally contain oxygen atoms, they necessarily contain both Eu²⁺ and Eu³⁺. The Eu-containing compounds, therefore, are preferably melted under Br gas-atmosphere so that oxygen-free EuBr₂ can be prepared.

The evaporation source preferably has a water content of not more than 0.5 wt. %. For preventing the source from bumping, it is particularly important to control the water content in the above low range if the compound of matrix or activator is a hygroscopic substance such as EuBr or CsBr. The compounds are preferably dried by heating at 100 to 300° C. under reduced pressure. Otherwise, the compounds may be heated under dry atmosphere such as nitrogen gas atmosphere to melt at a temperature above the melting point for several minutes to several hours.

The evaporation source, particularly the source containing the matrix compound, may contain impurities of alkali metal (alkali metals other than ones constituting the phosphor) in a content of 10 ppm or less and impurities of alkaline earth metal (alkaline earth metals other than ones constituting the phosphor) preferably in a content of 5 ppm or less (by weight). That is particularly preferred if the phosphor is an alkali metal halide stimulable phosphor represented by the aforementioned formula (I). Such preferred evaporation source can be prepared from compounds containing little impurities.

The two or more evaporation sources and the substrate are placed in a vacuum evaporation-deposition apparatus. The apparatus is then evacuated to give a medium vacuum of 0.1 to 10 Pa, preferably 0.1 to 4 Pa. It is particularly preferred that, after the apparatus is evacuated to a high vacuum of 1×10⁻⁵ to 1×10⁻² Pa, an inert gas such as Ar, Ne or N₂ gas be introduced into the apparatus so that the inner pressure can be the above-mentioned medium vacuum. In this case, partial pressures of water and oxygen can be reduced. The apparatus can be evacuated by means of an optional combination of, for example, a rotary pump, a turbo molecular pump, a cryo pump, a diffusion pump and a mechanical booster.

For heating the evaporation sources, electric currents are then supplied to resistance heaters. The sources of matrix and activator compounds are thus heated, vaporized, and reacted with each other to form the phosphor, which is deposited and accumulated on the underlayer. The space between the substrate and each source varies depending upon various conditions such as the size of substrate, but generally is in the range of 10 to 1,000 mm, preferably in the range of 10 to 200 mm. The space between the adjoining sources generally is in the range of 10 to 1,000 mm, In this step, the substrate can be heated or cooled. The temperature of the substrate generally is kept in the range of 20 to 350° C., preferably in the range of 100 to 300° C. The deposition rate, which means how fast the formed phosphor is deposited and accumulated on the substrate, can be controlled by adjusting the electric currents supplied to the heaters. The deposition rate generally is in the range of 0.1 to 1,000 μn/min, preferably in the range of 1 to 100 μn/min.

In advance of a deposition of the phosphor layer, a underlayer comprising mainly the matrix compound can be formed on the substrate (i.e., metal sheet). The underlayer and the phosphor layer can be deposited successively on the substrate. This can be carried out by first heating and evaporating an evaporation source of an matrix compound only, to deposit the matrix compound on the substrate to form the underlayer, and then heating and evaporating the evaporation source of matrix compound and the evaporation source of an activator compound simultaneously, to deposit the desired phosphor on the underlayer.

After the deposition procedure is complete, the deposited layer is preferably subjected to heat treatment (annealing), which is carried out generally at a temperature of 100 to 300° C. for 0.5 to 3 hours, preferably at a temperature of 150 to 250° C. for 0.5 to 2 hours, under inert gas atmosphere which may contain a small amount of oxygen gas or hydrogen gas.

Thus formed deposited layers are composed of the underlayer comprising a matrix compound of the phosphor and the phosphor layer comprising an energy-storable phosphor in the form of columnar structure grown almost in the thickness direction. The phosphor layer generally has a thickness of 50 μm to 1 mm, preferably 200 μm to 700 μm.

The gas phase-accumulation method employable in the invention is not restricted to the above-described resistance heating procedure, and various other known processes such as a sputtering process and a CVD process can be used.

It is preferred to provide a protective layer on the surface of the phosphor layer, so as to ensure good handling of the storage panel in transportation and to avoid damage. The protective layer is preferably transparent so as not to prevent the stimulating light from coming in or not to prevent the emission from coming out. Further, for protecting the storage panel from chemical deterioration and physical damage, the protective layer preferably is chemically stable, physically strong, and of high moisture proof.

Thus, a radiation image storage panel of the invention can be produced. The radiation image storage panel of the invention can be in known various structures. For example, in order to improve the sharpness of the resultant image, at least one layer may be colored with a colorant which does not absorb the stimulated emission but the stimulating light.

### EXAMPLE 1

(1) Evaporation Source

As the evaporation sources, powdery cesium bromide (CsBr, purity: more than 4N) and powdery europium bromide (EuBr₂, purity: more than 3N) were prepared. Each powder was once melted to remove water. For instance, the powdery EuBr₂ was placed in a platinum crucible and heated to 800° C. in a tube furnace under halogen atmosphere. Each was analyzed according to ICP-MS method (Inductively Coupled Plasma Mass Spectrometry), to examine contents of impurities. As a result, the CsBr powder contained each of the alkali metals (Li, Na, K, Rb) other than Cs in an amount of 10 ppm or less and other elements such as alkaline earth metals (Mg, Ca, Sr, Ba) in amounts of 2 ppm or less. The EuBr₂ powder contained each of the rare earth elements other than Eu in an amount of 20 ppm or less and other elements in amounts of 10 ppm or less. The evaporation sources were very hygroscopic, and hence were stored in a desiccator keeping a dry condition whose dew point was lower than −20° C. They were taken out of the desiccator, just before they were used.

(2) Preparation of Substrate

An aluminum sheet (rolled product, named SL meaning a sheet having a low surface roughness, available from Sumitomo Metal Industries, Co., Ltd., thickness 1 mm) were defatted by washing successively with an aqueous weak alkaline solution and de-ionized water. Thus washed substrate was then dried and kept in a sealed vessel.

(3) Deposition of Phosphor Layer

The washed and dried aluminum sheet was taken out of the vessel and then mounted to a substrate holder in an evaporation-deposition apparatus. Each of the CsBr and EuBr₂ evaporation sources were individually placed in crucibles equipped with resistance heaters, respectively. The evaporation sources were placed at spaces of 150 mm from the aluminum sheet. The apparatus was then evacuated to make the inner pressure 1×10⁻³ Pa by opening a main exhaust valve and using a combination of a rotary pump, a mechanical booster and a diffusion pump. Further, a cryo pump was operated to remove water vapor from the apparatus. Subsequently, the main valve was closed and a bypass valve was opened to introduce Ar gas to set the inner pressure at 0.5 Pa. Thereafter, a plasma generation apparatus (i.e., ion gun) was activated to generate plasma to wash the surface of the aluminum sheet. Then, the bypass valve was closed and the main valve was again opened to set the inner pressure to 1×10⁻³ Pa. The main valve was again closed, and the by-pass valve was again opened, to set the inner pressure to 1 Pa (Ar gas pressure). While a shutter placed between the substrate and each source was closed, each evaporation source was heated by means of the resistance heater. The shutter covering the CsBr source was first opened so that CsBr alone was accumulated on the aluminum sheet to form an underlayer of CsBr matrix compound. At a lapse of 3 min. after the underlayer was formed on the aluminum sheet, the shutter covering the EuBr₂ source was then opened so that stimulable CsBr:Eu phosphor was accumulated on the underlayer at the rate of 8 μm/min., to form a phosphor layer comprising the phosphor in the form of columnar crystalline structure grown almost perpendicularly and aligned densely (thickness: 500 μm, area: 10 cm×10 cm). During the deposition, the electric currents supplied to the heaters were controlled so that the molar ratio of Eu/Cs in the phosphor would be 0.003/1. After the evaporation-deposition was complete, the inner pressure was returned to atmospheric pressure and then the aluminum sheet was taken out of the apparatus.

Thus, a radiation image storage panel of the invention (See FIGURE) comprising the aluminum sheet and phosphor layer was produced by co-deposition.

### EXAMPLE 2

The procedures of Example 1 were repeated except that the surface of the aluminum sheet was subjected to electrolytic polishing before the phosphor layer was deposited, to give a radiation image storage panel of the invention.

### EXAMPLE 3

The procedures of Example 1 were repeated except that the surface of the aluminum sheet was plated with nickel before the phosphor layer was deposited, to give a radiation image storage panel of the invention.

### EXAMPLE 4

The procedures of Example 1 were repeated except that the surface of the aluminum sheet was plated with chromium before the phosphor layer was deposited, to give a radiation image storage panel of the invention.

### EXAMPLE 5

The procedures of Example 1 were repeated except that the surface of the aluminum sheet was subjected to electrolytic polishing and then coated with a transparent silicon dioxide layer (thickness 4 μm, produced by coating the polished surface of the aluminum sheet with a silicon alkoxide solution (available from Nikko Co., Ltd., GS-600-1, solid content: 36%), drying the coated surface for 30 min. at 25° C., 40% RH, and heating the dried surface to 200° C. for one hour), before the phosphor layer was deposited, to give a radiation image storage panel of the invention.

### EXAMPLE 6

The procedures of Example 1 were repeated except that an aluminum sheet (thickness 10 mm, JIS name 7075, trade name YH-75, available from Nittetsu Trading Co., Ltd.) whose one surface was previously subjected to lapping polishing was employed, to give a radiation image storage panel of the invention.

### EXAMPLE 7

The procedures of Example 6 were repeated except that the aluminum sheet (thickness 10 mm) subjected to lapping polishing was then coated with a transparent silicon dioxide layer (thickness 4 μm) in advance of the deposition of the phosphor layer, to give a radiation image storage panel of the invention.

### COMPARISON EXAMPLE 1

The procedures of Example 1 were repeated except that an aluminum sheet (thickness 1 mm, rolled product, named MF, available from Sumitomo Metal Industries, Co. Ltd.) was employed with no additional surface treatment, to give a radiation image storage panel for comparison.

### COMPARISON EXAMPLE 2

The procedures of Example 1 were repeated except that an aluminum sheet (thickness 1 mm, rolled product, named LF, available from Sumitomo Metal Industries, Co. Ltd.) was employed with no additional surface treatment, to give a radiation image storage panel for comparison.

[Evaluation of Radiation Image Storage Panel]

The aluminum sheet was subjected to the measurements of surface roughness (Ra) and the maximum height (Rz) of surface roughness, and a radiation image reproduced using the radiation image storage panel was evaluated in its image quality.

(1) Surface Roughness (Ra) and Maximum Height (Rz) of Surface Roughness

The surface of the aluminum sheet was scanned by means of a microscope for measuring a surface ultra-depth condition (VK-8550, available from Keyence Corporation) in a square area (100 μm×100 μm) with a height-measuring pitch (measuring resolution) of 0.01 μm, and the resulting data are processed according to the calculation formula defined in JIS B 0601-2001 using a image measuring-analyzing software (VK-H1A7) to give the desired surface roughness (Ra) in terms of arithmetic mean roughness and maximum height (Rz) of surface roughness.

(2) Graininess of the Reproduced Radiation Image

The radiation image storage panel was exposed to 10 mR (2.58×10⁻⁶ C/kg) of X rays emitted by a tungsten tube (tube voltage 80 kVp). The exposed storage panel was then irradiated with a semi-conductor laser light (wave length 660 nm) to give an exciting energy of 5 J/m². A stimulated emission produced on the storage panel was collected by a detector (photomultiplier having an optical resolution S-5). The collected emission was converted into series of electric signals. The electric signals were then processed in an image-reproducing apparatus to give a reproduced radiation image. The reproduced radiation image was visually examined to evaluate graininess of the image (relating the structural mottle of storage panel, except for defective points). The results of evaluation were marked as follows:
AA: Excellent
A: Good
B: Somewhat poor but acceptable from viewpoint of practical use
C: Apparently poor and not acceptable
   (3) Defective Points on the Reproduced Radiation Image

The radiation image reproduced in (2) above was visually examined to count number of defective points (points showing an optical density apparently differing the optical density in the surrounding area) in the area of 100 mm×100 mm.

(4) Overall Judgement of Image Quality

The image quality of the reproduced radiation image was marked in consideration of the observed graininess and the number of the defective points, according to the following criteria:
AA: Excellent
A: Good
B: Somewhat poor but acceptable from viewpoint of practical use
C: Apparently poor and not acceptable

The results are summarized in the following Table 1.

TABLE 1

| | Al sheet/ | Ra/Rz | | Defective | Overall |
|---|---|---|---|---|---|
| | treatment | (μm) | Graniness | points | judgement |
| Ex. 1 | SL (none) | 0.074/1.20 | A | 8 | A |
| Ex. 2 | SL (electrolytic | 0.048/0.46 | AA | 2 | AA |
| | polishing) | | | | |
| Ex. 3 | SL (Ni plating) | 0.054/0.45 | AA | 3 | AA |
| Ex. 4 | SL (Cr plating) | 0.052/0.43 | AA | 3 | AA |
| Ex. 5 | SL (electrolytic | 0.040/0.25 | AA | 1 | AA |
| | polishing + | | | | |
| | SiO₂ layer) | | | | |
| Ex. 6 | YH-75 (lapping | 0.044/0.52 | AA | 3 | AA |
| | polishing) | | | | |
| Ex. 7 | YH-75 (lapping | 0.038/0.21 | AA | 1 | AA |
| | polishing + | | | | |
| | SiO₂ layer) | | | | |
| Com. 1 | MF (none) | 0.196/5.05 | C | 20 | C |
| Com. 2 | LF (none) | 0.130/1.84 | B | 12 | B |

As is apparent from the results set forth in Table 1, all of the radiation image storage panels (Examples 1 to 7) utilizing an aluminum sheet of a surface roughness of lower than 0.1 μm reproduces a radiation image showing satisfactory graininess and having little defective points. Particularly, the radiation image storage panels of Examples 2 to 7 utilizing an aluminum sheet of a surface roughness of lower than 0.06 μm gives a reproduced radiation image of improved graininess and reduced defective points. In contrast, the radiation image storage panels (comparison Examples 1 and 2) utilizing an aluminum sheet of a surface roughness of higher than 0.1 μm gives a reproduced radiation image of poor graininess having a relatively large number of defective points.

1. A radiation image storage panel comprising a metal sheet and a phosphor layer formed on one surface of the metal sheet by gas phase-accumulation, in which the metal sheet has a surface having a surface roughness Ra of 0.1 μm or lower.

2. The radiation image storage panel of claim 1, wherein the surface roughness Ra is in the range of 0.005 to 0.06 μm.

3. The radiation image storage panel of claim 1, wherein the surface of the metal sheet has a maximum height of surface roughness Rz of 1.5 μm or lower.

4. The radiation image storage panel of claim 1, wherein the surface of the metal sheet has a maximum height of surface roughness Rz of 1.0 μm or lower.

5. The radiation image storage panel of claim 1, wherein the metal sheet is an aluminum sheet.

6. The radiation image storage panel of claim 1, wherein the surface of the metal sheet is polished.

7. The radiation image storage panel of claim 1, wherein the surface of the metal sheet is metal-plated.

8. The radiation image storage panel of claim 7, wherein the surface of the metal sheet is plated with nickel or chromium.

9. The radiation image storage panel of claim 1, wherein the surface of the metal sheet is coated with a transparent oxide layer.

10. The radiation image storage panel of claim 1, wherein the phosphor is an energy-storable phosphor.

11. The radiation image storage panel of claim 10, wherein the energy-storable phosphor is a stimulable alkali metal halide phosphor represented by the formula (I):
M^{I}X·aM^{II}X′₂·bM^{III}X″₃:zA (I)
in which M^{I} is at least one alkali metal selected from the group consisting of Li, Na, K, Rb and Cs; M^{II} is at least one alkaline earth metal or divalent metal selected from the group consisting of Be, Mg, Ca, Sr, Ba, Ni, Cu, Zn and Cd; M^{III} is at least one rare earth element or trivalent metal selected from the group consisting of Sc, Y, La, Ce, Pr, Nd, Pm, Sm, Eu, Gd, Th, Dy, Ho, Er, Tm, Yb, Lu, Al, Ga and In; each of X, X′ and X″ is independently at least one halogen selected from the group consisting of F, Cl, Br and I; A is at least one rare earth element or metal selected from the group consisting of Y, Ce, Pr, Nd, Sm, Eu, Gd, Tb, Dy, Ho, Er, Tm, Yb, Lu, Mg, Cu and Bi; and a, b and z are numbers satisfying the conditions of 0≦a<0.5, 0≦b<0.5 and 0<z<1.0, respectively.

12. The radiation image storage panel of claim 11, wherein M^{I} is Cs, X is Br, A is Eu, and z is a number satisfying the condition of 1×10⁻⁴≦z<0.1.
